(19) United States
(12) Patent Application Publication
(10) Pub. No.: US 2007/0204476 A1
(43) Pub. Date: Sep. 6, 2007

(54) Metal yardstick with slots

(76) Inventor: Stan Brothers, Glendale, CA (US)

Correspondence Address: Wilson Daniel Swayze, Jr., 3804 Clearwater Ct., Plano, TX, 75025, US

(21) Appl. No.: 11/365,388

(22) Filed: Mar. 1, 2006

(51) Int. Cl. B43L 7/00

(52) U.S. Cl. 33/483

(57) ABSTRACT

A measuring device for measuring an object includes a first measuring scale positioned along a first edge of the measuring device, a first slot formed through the measuring device, and a second measuring scale positioned alongside the first slot.

### FIELD OF THE INVENTION

The present invention relates to the field of measuring instruments in general and in particular to a ruler having a first slot for pencil points, markers and larger blades for example and a second slot for craft knives, exact-o knives and precise razor cuttings for example.

### BACKGROUND OF THE INVENTION

Measuring instruments, drawing instruments, guiding devices, measuring tools, angle gauges, drafting apparatus and aids, and framing tools and the like having various design structures configurations and materials of construction have been disclosed in the prior art.

One such ruler is disclosed in U.S. Pat. No. 6,851,196 that can be used for cutting sheets of material perpendicular to its longitudinal edge of rigid material. The ruler includes a groove placed in the rigid material to aid in the direction of a sharpened instrument along the groove while cutting material.

A measuring instrument is disclosed in U.S. Pat. No. 6,141,882 which discloses that the measuring instrument can be used with drawings, employing different scales with indicia. The measuring instrument includes elongated first and second instrument member arms.

Additionally, U.S. Pat. No. 6,895,683 discloses a layout tool for use by carpenters including a left foot and a right foot connected by a connecting bar.

### SUMMARY OF THE INVENTION

The measuring aspects of the present invention are twofold and straightforward and include devices that allow for measuring objects with a degree of accuracy. Additionally, the measuring aspects of the present invention allow for placement over or near the material to be cut or marked, for example, a piece of linoleum and allow for precision marking of the material. The measuring aspects of the present invention includes two scaled measured slots having differing widths that are formed completely through the measuring device in order that marking devices of different widths can be accommodated, such as a pencil, awl, felt marker or other suitable devices, and a scaled numbered measurement array on the outer edges of the device. The slots will aid in marking the material precisely by not allowing the marking device to deviate from a line as can happen when a craft person works with a ruler or yardstick. Holes are formed completely through the device precisely on the numbers of the rule scale to aid in the exact linear marking of materials and also to allow for the precise drawing of circles with a pin, nail or similar device is placed in a hole formed completely through the device at another point on the same axis.

Additionally, holes of different diameters may be formed completely through the device at either end of the device and along the body will allow for the insertion of pushpins, nails, small screws or similar objects to secure an unwavering placement of the device on the material to be cut or marked and/or to a board or backing material behind the item being marked or cut.

The cutting aspect of the present invention stems from its use, once securely in place, to confine a cutting instrument to a narrow channel slightly wider than the thickness of the cutting blade in order to render an precision cut without the lateral deviation which often occurs when cutting resilient material freehand or with the aid of a single straight edge alone, especially when the cuts require multiple passes with a cutting instrument to fully cleave the material. The present invention is designed in such a way as to allow the razor knife to pass precisely but unhampered through the narrower of the two longitudinal slots, which has a kerf of approximately 1 mm. The wider longitudinal slot can be used with the same purpose and accepts a wider blade such as a linoleum knife, serrated knife and thin saw blade and may have a kerf of approximately 1.5 mm.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the measuring device of the present invention;

FIG. 2 illustrates a sectional view of the measuring device of the present invention.

### DETAILED DESCRIPTION

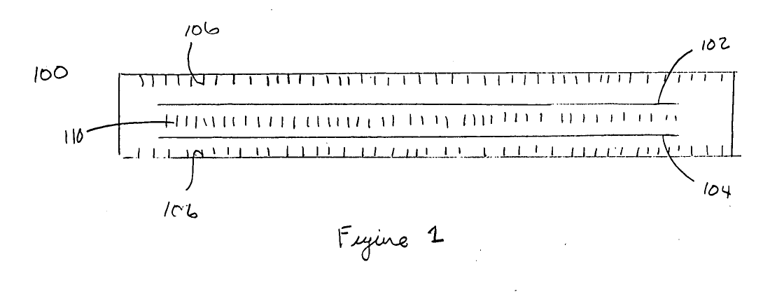

FIG. 1 shows the measuring device 100 being a longitudinal piece of rigid material and being substantially rectangular or other shape and having a first measuring scale 106 formed along the longitudinal edge of the measuring device 100. The first measuring scale 106 allows the measuring device 100 to be accurately positioned adjacent to an object or to allow the object to be accurately measured. FIG. 1 additionally shows another first measuring scale 106 along the opposing longitudinal edge of the measuring device 100. The other first measuring scale 106 along the opposing longitudinal edge of the measuring device could be in a different scale or could be eliminated without departing from the teachings of the present invention.

FIG. 1 additionally shows a second measuring scale 110 positioned approximately in the center of the measuring device 100 and running along the longitudinal direction of the measuring device 100. The second measuring scale 110 may be a yard long and indicate inches or another convenient measuring scale. Adjacent to and on either side of the the second measuring scale 110 is a first slot 102 and a second slot 104. The first slot 102 and the second slot 104 extends through the measuring device 100 so that the object positioned on the back side of the measuring device 100 may be marked or cut using the second measuring scale 110 to achieve an accurately measured mark or cut. The first slot 102 may have a different width then the second slot 104 to accommodate different sized marking or cutting devices. For example, the first slot 102 may be 1.5 mm in width in order to accommodate pencil points, markers or thick blades. The second slot 104 may be 0.5 mm wide in order to accommodate smaller devices such as craft knives, exact-o knives or razor blades to provide a precise cut. The first slot 102 and the second slot 104 may extend for the same length in the longitudinal direction of the measuring device 100 or could be of unequal lengths. The second indicia may not extend beyond either the first slot 102 or the second slot 104. If the smaller cutting or marking devices were used with the larger first slot 102, accuracy in the mark or cut could be lost because the smaller devices could wobble and not run straight within the first slot 102. By using the smaller devices within the second slot 104, the wobble is eliminated because the size of the smaller devices corresponds more precisely with the width of the second slot 104.

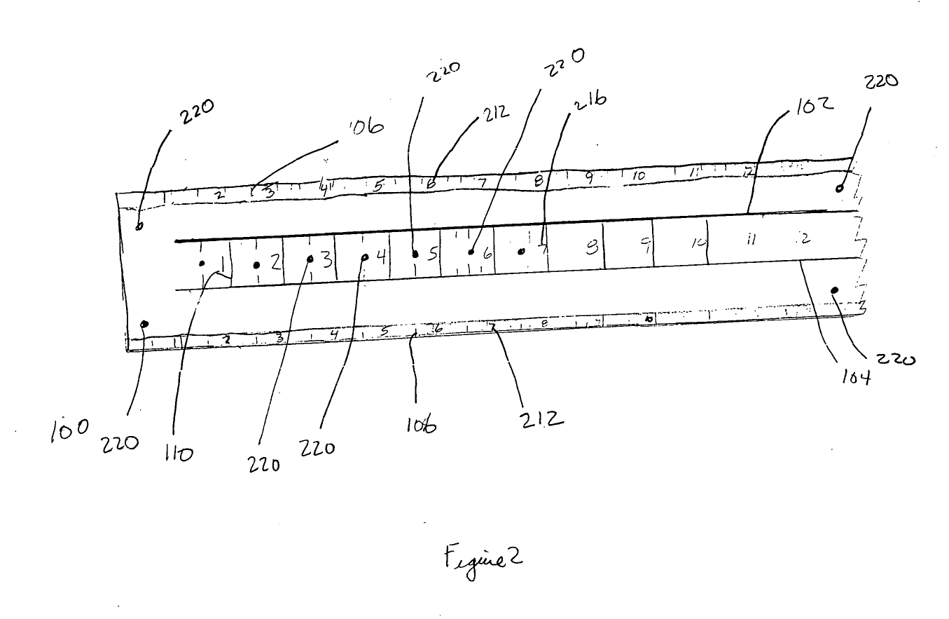

FIG. 2 illustrates a detailed portion of the measuring device 100. FIG. 2 shows first indicia 212 that can be used in conjunction with the first measuring scale 106 in order to achieve the accurate measurement. FIG. 2 illustrates that the first indicia 212 is formed on both the upper and lower edge of the measuring device 100. Additionally, FIG. 2 shows the second indicia 216 that can be used in conjunction with the second measuring scale 110. FIG. 2 illustrates mounting holes 220 to aid in the mounting of the measuring device 100, and FIG. 2 illustrates marking holes 222 to aid in marking the object underneath the measuring device 100. The marking holes 222 may be of different diameters and positioned along a longitudinal line of the measuring device 100.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A measuring device for measuring an object, comprising:
a first measuring scale positioned along a first edge of said measuring device;
a first slot formed through said measuring device;
a second measuring scale positioned at an edge of said first slot.

2) A measuring device for measuring an object as in claim 1, wherein said measuring device includes a second slot formed through said measuring device.

3) A measuring device for measuring an object as in claim 2, wherein said second measuring scale is formed between said first slot and said second slot.

4) A measuring device for measuring an object as in claim 1, wherein said second measuring scale is positioned along the edge of said first slot.

5) A measuring device for measuring an object as in claim 1, wherein said measuring device includes another first measuring scale positioned along a second edge of said measuring device.

6) A measuring device for measuring an object as in claim 1, wherein said first slot is positioned in a longitudinal direction of said measuring device.

7) A measuring device for measuring an object as in claim 1, wherein said measuring device includes a first indicia corresponding to said first measuring scale.

8) A measuring device for measuring an object as in claim 1, wherein said measuring device includes a second indicia corresponding to said second measuring scale.

9) A method for forming a measuring device for measuring an object, comprising the steps of:
forming a first measuring scale positioned along a first edge of said measuring device;
forming a first slot through said measuring device; forming a second measuring scale positioned alongside said first slot.

10) A method for forming a measuring device for measuring an object as in claim 9, wherein said measuring device includes the step of forming a second slot formed through said measuring device.

11) A method for forming a measuring device for measuring an object as in claim 10, wherein said second measuring scale is formed between said first slot and said second slot.

12) A method for forming a measuring device for measuring an object as in claim 9, wherein the method includes the step of positioning said second measuring scale along the edge of said first slot.

13) A method for forming a measuring device for measuring an object as in claim 9, wherein said measuring device includes the step of forming another first measuring scale along a second edge of said measuring device.

14) A method for forming a measuring device for measuring an object as in claim 9, wherein the method includes the step of positioning said first slot in a longitudinal direction of said measuring device.

15) A method for forming a measuring device for measuring an object as in claim 9, wherein said method includes the step of forming a first indicia corresponding to said first measuring scale.

16) A method for forming a measuring device for measuring an object as in claim 9, wherein said method includes the step of forming a second indicia corresponding to said second measuring scale.
